(19) United States
(12) Patent Application Publication
(10) Pub. No.: US 2010/0066918 A1
(43) Pub. Date: Mar. 18, 2010

(54) MOBILE TELEVISION CONTROL LOGIC AND METHOD FOR IMPROVED CHANNEL SWITCHING TIME

(75) Inventors: Pankaj Gupta, Madhapur (IN); Apoorva Kakkeri, Barkatpura (IN); Ajay Kumar, Banjara Hills (IN)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 12/246,838

(22) Filed: Oct. 7, 2008

(30) Foreign Application Priority Data
Sep. 12, 2008 (IN) 2227/CHE/2008

(51) Int. Cl. H04N 5/445; H04N 5/44

(52) U.S. Cl. 348/734; 725/38; 348/E05.096

(57) ABSTRACT

A method, control logic, and executable instructions stored in memory enable faster switching between mobile television channels displayed on handheld devices. In one example, a tuner is controlled to receive a first wireless digital burst, such as a wireless digital burst of a digital video broadcasting-handheld (“DVB-H”) signal, including first channel information. The first channel information corresponds to a first mobile television channel to be displayed, and video based on the first channel information is provided. If desired, battery power consumption by the handheld device is then reduced by turning off the tuner. The tuner is then turned on to receive a second wireless digital burst including second channel information. The second channel information corresponds to the second mobile television channel to be displayed. The second channel information is buffered in a buffer while the video based on the first channel information is provided. If desired, battery power consumption is then reduced by again turning off the tuner. The tuner is again turned on to receive another burst.

### FIELD OF THE INVENTION

The disclosure relates to a method and apparatus for switching between the display of different mobile television channels.

### BACKGROUND OF THE INVENTION

Increasingly, mobile television services are being offered over broadcast networks to users of mobile or handheld devices. In providing such mobile television services, a cellular telephone or other portable handheld device is integrated with a mobile television receiver. For example, the mobile television receiver may function separately from a cellular telephone portion of a handheld device, but may use the same audio/visual encoder-decoder (“codec”) or accelerator modules and the same display as the cellular telephone portion. The mobile television receiver may be tuned to a desired channel of an available list of mobile television channels. The channel information is transmitted to the mobile television receiver as a series of high-bit-rate wireless digital bursts of data which are spaced apart in time. Each wireless digital burst may contain channel information corresponding to a single or more channels, depending on the data rate of the wireless digital burst and the audio and visual quality desired. Many such consecutive bursts constitute all the mobile television channels being offered by a service provider. A tuner in the mobile television receiver must properly synchronize with the wireless digital bursts for proper reception of the desired mobile television channel. As one mobile television channel is displayed, a user of the handheld device may use an appropriate peripheral device, such as a keypad, to input a command to “zap” to a new mobile television channel; that is, to switch to displaying a new mobile television channel.

However, the new mobile television channel may not be contained in the same wireless digital burst as the previously displayed mobile television channel. Thus, in known mobile television receivers, at the time a user of a handheld device inputs the command to select the new mobile television channel, the tuner in the mobile television receiver must be retuned to receive different wireless digital bursts corresponding to the new mobile television channel. Moreover, the display of mobile television content corresponding to a particular mobile television channel requires extensive demodulation and filtering operations, among other operations, of signals received from the tuner. In known mobile television receivers, these operations must be performed in their entirety at the time the user of the handheld device inputs the command to select the new mobile television channel and must continue to be performed in their entirety until the mobile television channel is switched again or the handheld device is turned off. Therefore, in case of a command to select a new mobile television channel, the need to return and perform a second set of demodulation and filtering operations creates an undesirable delay of one to two seconds or more between the time at which the user of the handheld device inputs the command to select the new mobile television channel and the time at which the new mobile television channel is actually displayed.

Therefore, a need exists that overcomes one or more of the above problems.

### BRIEF DESCRIPTION OF THE DRAWINGS

The invention will be more readily understood in view of the following description when accompanied by the below figures and wherein like reference numerals represent like elements, wherein:

FIG. 1 is a block diagram illustrating one example of a handheld device in accordance with one embodiment set forth in the disclosure;

FIG. 2 is a flowchart illustrating one example of a method in accordance with one embodiment set forth in the disclosure;

FIG. 3 is a block diagram illustrating one example of a handheld device in accordance with another embodiment set forth in the disclosure;

FIG. 4 is a flowchart illustrating one example of a method in accordance with another embodiment set forth in the disclosure; and

FIG. 5 is a flowchart illustrating one example of a method in accordance with another embodiment set forth in the disclosure.

### DETAILED DESCRIPTION OF THE PREFERRED EMBODIMENTS

Briefly, a method, control logic, and executable instructions stored in memory enable faster switching between mobile television channels displayed on handheld devices. In one example, a tuner is controlled to receive a first wireless digital burst, such as a wireless digital burst of a digital video broadcasting-handheld (“DVB-H”) signal, including first channel information. The first channel information corresponds to a first mobile television channel to be displayed, and video based on the first channel information is provided. If desired, battery power consumption by the handheld device is then reduced by turning off the tuner. The tuner is then turned on to receive a second wireless digital burst including second channel information. The second channel information corresponds to the second mobile television channel to be displayed. The second channel information is buffered in a buffer while the video based on the first channel information is provided. If desired, battery power consumption is then reduced by again turning off the tuner. If desired, while the video based on the first channel information is provided, a second mobile television channel to be displayed is determined. In one example, the second mobile television channel to be displayed is determined by predicting a next channel that will be displayed based on detected user channel navigation information, which may be information regarding a user's prior channel usage or a user's usage or navigation of an electronic service guide (“ESG”). After determining the second mobile television channel to be displayed,

The tuner is may also be turned on to receive a third wireless digital burst, which may include the first channel information or channel information for another mobile television channel to be displayed. When the second mobile television channel is selected for display, the second channel information is accessed from the buffer and second video based on the second channel information is provided. The tuner is then controlled to receive the first channel information in forthcoming bursts, such as a fourth wireless digital burst. The first channel information is buffered in the buffer while the second video based on the second channel information is provided.

In the following detailed description, numerous specific details are set forth in order to provide a thorough understanding of the present disclosure. It will be apparent to one of ordinary skill in the art, however, that these specific details need not be used to practice the present disclosure. In other instances, well-known structures, interfaces and processes have not been shown or described in detail in order not to unnecessarily obscure the present invention.

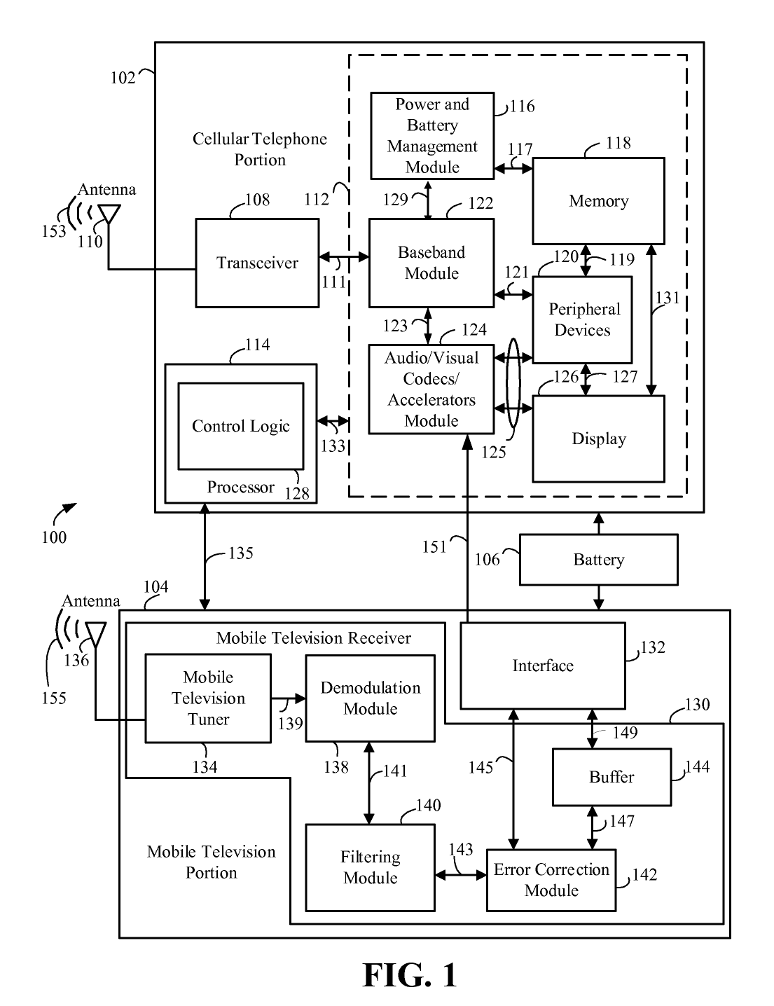

FIG. 1 illustrates one example of a handheld device 100, such as but not limited to a cellular telephone, a portable television console, a handheld game console, a personal digital assistant (“PDA”), or any other suitable handheld device. In exemplary FIG. 1, the handheld device 100 includes a cellular telephone portion 102, a mobile television portion 104, and a battery 106 operatively coupled to and providing power to the cellular telephone portion 102 and the mobile television portion 104. The battery 106 may be any suitable battery as known in the art.

The handheld device 100 may include, in place of the cellular telephone portion 102, a portable television console portion, a gaming console portion (such as an Xbox console manufactured by Microsoft Corporation or a Wii console manufactured by Nintendo of America Inc.), a PDA portion, or any other suitable portion as known in the art that operates in conjunction with the mobile television portion 104 and the battery 106 in the manner described below.

The cellular telephone portion 102 includes a transceiver 108, a cellular telephone subsystem 112, and a processor 114. The transceiver 108 includes an antenna 110. The cellular telephone subsystem 112 includes a power and battery management module 116, memory 118, a peripheral device or devices 120, a baseband module 122, an audio/visual codecs or accelerators module 124, and a display 126. The processor 114 includes control logic 128.

The antenna 110 may be any suitable antenna as known in the art for receiving cellular telephone network signals 153. The transceiver 108 may be any suitable transceiver as known in the art for processing the cellular telephone network signals 153 after reception by the antenna 110 and providing, for example, baseband data 111 to the baseband module 122.

The baseband module 122 may be any suitable baseband module as known in the art which converts, for example, the baseband data 111 received from the transceiver 108 from the analog domain to the digital domain.

The audio/visual codecs or accelerators module 124 is operatively coupled to the baseband module 122 and is operative to receive digital data 123 from the baseband module and to decode the digital data 123 to produce corresponding voice and video data 125. The audio/visual codecs or accelerators module 124 may be any suitable audio/visual codecs or accelerators module 124 as known in the art for decoding the digital data 123. The audio/visual codecs or accelerators module 124 provides the voice and video data 125 to the display 126 and to the peripheral devices 120. The display 126 may be any suitable type of display as known in the art. The peripheral devices 120 may be any suitable type of peripheral devices as known in the art. As known in the art, the peripheral devices 120 may be further operatively coupled to one or more of the baseband module 122 and the display 126, respectively, through peripheral device communication links 121 and 127, respectively, to enable data transfer between the peripheral devices 120, the baseband module 122, and the display 126.

As will be recognized by one of ordinary skill in the art, the above operation of the cellular telephone portion 102 has been described for purposes of receiving and processing cellular telephone network signals 153. The above operations may be performed in a suitable reverse fashion as known in the art in order to transmit voice and video data over a cellular telephone network.

The power and battery management module 116 may be any suitable type of power and battery management module as known in the art for selectively increasing or reducing the power supplied to the other components of the cellular telephone portion 102 based on usage of these components in order to maximize the life of the battery 106. As shown in FIG. 1, the power and battery management module 116 is operatively coupled to the memory 118 and the baseband module 122, respectively, through power and battery management communication links 117 and 129, respectively, but it will be understood that the power and battery management module 116 may be coupled to any of the components of the cellular telephone portion 102 as appropriate to maximize the life of the battery 106.

The memory 118 may include any suitable type of memory as known in the art, such as one or more random access memories (“RAMs”), read-only memories (“ROMs”), flash memories, cache memories, or any suitable type of memory. As known in the art, the memory 118 may be operatively coupled to the peripheral devices 120 through memory communication link 119, to the display 106 through display communication link 131, and (not shown in FIG. 1) to any other suitable components of the cellular telephone portion 102. In this example, the memory 118 may store executable instructions that, when executed by the processor 114, cause the processor 114 to contain the control logic 128.

In another embodiment, memory that contains the executable instructions that cause one or more processors to contain the control logic 128 may be distributed memory in one or more Internet servers, any other suitable memory remote from the handheld device 100, or any suitable combination of memory local to the handheld device 100 and remote from the handheld device 100.

As will be recognized by one of ordinary skill in the art, the cellular telephone portion 102 need not be implemented in the precise manner described above. Rather, the present disclosure contemplates any suitable variations to the cellular telephone portion 102 as known in the art.

The processor 114 may be any suitable processor as known in the art, such as a central processing unit (“CPU”), microprocessor, or any suitable type of processor. The processor 114 is in bidirectional communication with and controls the operation of the cellular telephone subsystem 112 through control signals 133. The control logic 128 provides mobile television portion control signals 135 to control the operation of certain components of the mobile television portion 104 in the manner described below. In one embodiment, if desired, the control logic 128 may also control the display of video on the display 126 by appropriately controlling the control signals 133. In another embodiment, part or all of the control logic 128 may be included within the mobile television tuner 134. The control logic 128 may be implemented by executable instructions stored in memory which execute on the processor 114 as described above, as hardware (such as an ASIC), as firmware, as one or more state machines, as discrete logic, as a suitable combination of the above, or in any suitable manner. In one embodiment, the control logic 128 may be implemented by executable instructions stored not in memory 118 but in separate memory (not shown in FIG. 1) included within the mobile television portion 104 or any other suitable portion of the handheld device 100. Moreover, the control logic 128 may be standalone control logic or may be integrated with additional control logic present in the handheld device 100 to control other operations of the handheld device 100.

The mobile television portion 104 includes a mobile television receiver 130 and an interface 132. The mobile television receiver 130 includes a mobile television tuner 134, a second antenna 136, a demodulation module 138, a filtering module 140, an error correction module 142, and a buffer 144. As known in the art, the mobile television tuner 134, the demodulation module 138, the filtering module 140, and the error correction module 142 may be included on one integrated circuit, such as an ASIC. For example, the mobile television tuner 134, the demodulation module 138, the filtering module 140, and the error correction module 142 may be, respectively, a suitable mobile television tuner, demodulation module, filtering module, and error correction module such as the SMS 1010 mobile television receiver chip manufactured by Siano Mobile Silicon Ltd., or a suitable mobile television tuner, demodulation module, filtering module, and error correction module such as the DIB707x-H chipset manufactured by DiBcom, or any other suitable mobile television tuner, demodulation module, filtering module, and error correction module. In one embodiment, the buffer 144 is further included on the same integrated circuit as the other components of the mobile television receiver 130. In an alternate embodiment, the buffer 144 is within the mobile television portion 104 but physically separate from the integrated circuit which includes the other components of the mobile television receiver 130. In another alternate embodiment, the buffer 144 is within the cellular telephone portion 102. In still another alternate embodiment, the buffer 144 is physically separate from both the cellular telephone portion 102 and the mobile television portion 104.

The components of the mobile television receiver 130 may utilize the memory 118 of the cellular telephone portion 102 or the mobile television receiver 130 may further include a separate memory (not shown in FIG. 1).

The second antenna 136 may be any suitable antenna as known in the art for receiving a mobile television broadcast signal 155. The mobile television tuner 134 may be any suitable tuner as known in the art such as, for example, a suitable mobile television tuner on an integrated circuit as discussed above, a suitable mobile television tuner manufactured by Microtune, Inc. or Maxim Integrated Products, Inc., or any suitable tuner. Such tuners selectively receive one or more wireless digital bursts of the mobile television broadcast signal 155 from the second antenna 136, as described in further detail below, and convert the one or more wireless digital bursts of the mobile television broadcast signal 155 to modulated mobile television channel information 139, as known in the art.

The demodulation module 138 is operatively coupled to the mobile television tuner 134 and receives, in one embodiment, the modulated mobile television channel information 139 from the mobile television tuner 134. The demodulation module 138 may be any suitable demodulator as known in the art, such as, for example, a suitable demodulator on an integrated circuit as discussed above, or any suitable demodulator. Such demodulation modules are used to remove the carrier frequency from the modulated mobile television channel information 139 in order to produce demodulated data packets 141. The filtering module 140 is operatively coupled to the demodulation module 138 and may be any suitable filtering module as known in the art, such as, for example, a filtering module on an integrated circuit as discussed above, or any suitable filtering module, for receiving and filtering the demodulated data packets 141 based on their program (also referred to as packet) identification number (“PID”) to output filtered data packets 143. PIDs are mapped to the mobile television channels provided by the service to which the handheld device 100 subscribes. Thus, the demodulated data packets 141 are filtered based on the one or more mobile television channel IDs (or PIDs) selectively received by the mobile television tuner 134.

The error correction module 142 may be any suitable error correction module as known in the art, such as, for example, a suitable error correction module on an integrated circuit as discussed above, or any suitable error correction module, for further processing the filtered data packets 143 from the filtering module 140 in order to remove errors introduced during transmission of the mobile television broadcast signal 155 to the handheld device 100. The error correction module 142 produces first error-corrected data packets 145 and second error-corrected data packets 147. The first error-corrected data packets 145 and the second error-corrected data packets 147 may be in the form of transport stream packets or audio and video packets, as formatted by the other components of the mobile television receiver 130 as known in the art. For example, the error correction module 142 may employ forward error correction using Reed-Solomon (“RS”) codes to produce the first error-corrected data packets 145 and the second error-corrected data packets 147.

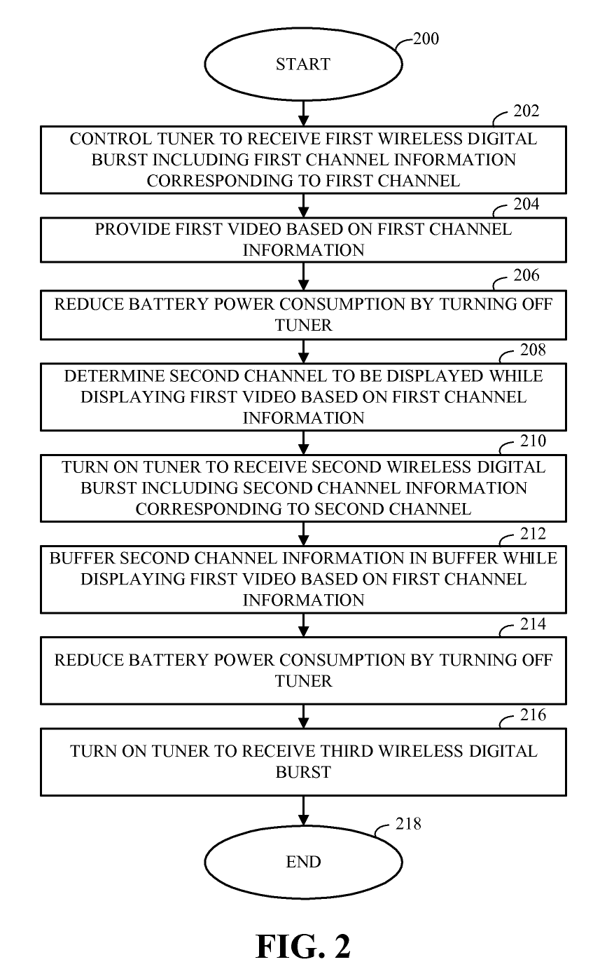

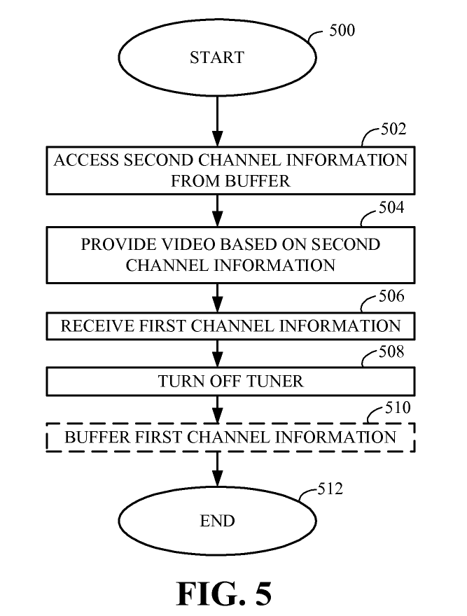

In accordance with one or more embodiments as discussed in further detail with respect to FIG. 2, the first error-corrected data packets 145 are input from the error correction module 142 to the interface 132. The second error-corrected data packets 147 are input from the error correction module 142 to the buffer 144. The buffer 144 may be any suitable buffer as known in the art which is capable of storing the second error-corrected data packets 147. As described in further detail with respect to FIG. 5, the buffer outputs buffered data packets 149 to the interface 132. The interface 132 may be any suitable interface as known in the art for the transmission of data packets to the cellular telephone portion 102. Specifically, the interface 132 transmits the first error-corrected data packets 145 and the buffered data packets 149 to the cellular telephone portion 102, as described in detail below. The interface 132 outputs the first error-corrected data packets 145 and the buffered data packets 149 as channel data packets 151 to the audio/visual codecs or accelerators module 124.

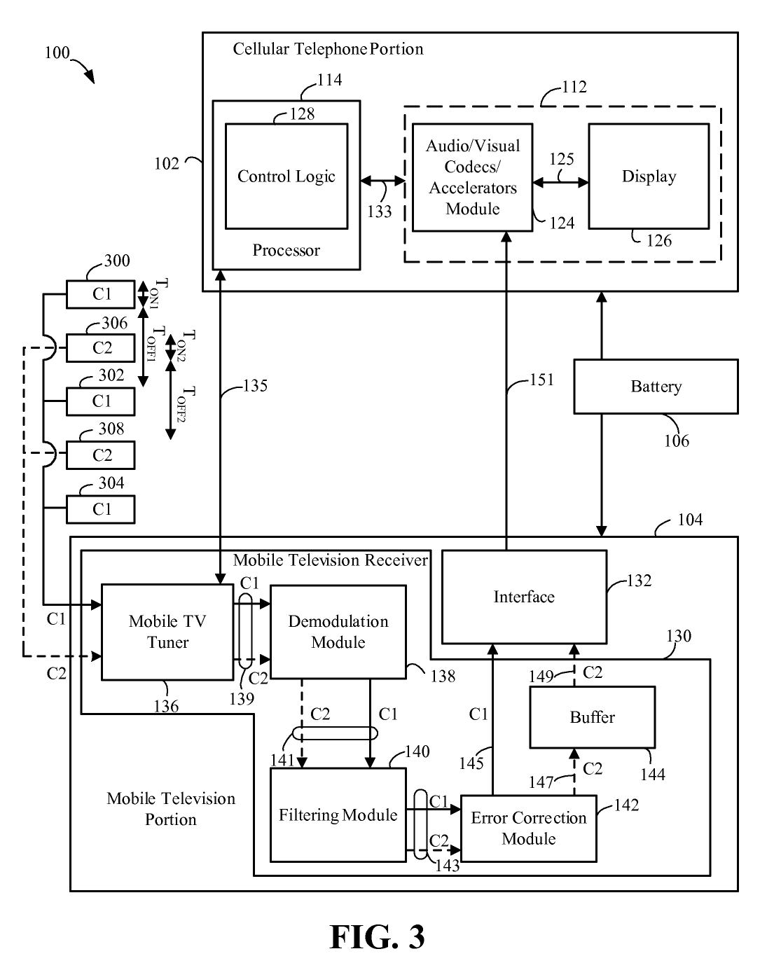

Referring now to FIG. 2, an exemplary method of controlling mobile television channel selection in a handheld device is illustrated. The method begins at block 200. In block 202, the method includes controlling a tuner to receive a first wireless digital burst including first channel information corresponding to a first channel. The first channel, as with all other channels discussed herein, may include, for example, programming content or ESG content. For example, the control logic 128 may be operative to control the mobile television tuner 134 to receive a first wireless digital burst of the mobile television broadcast signal 155 which includes first channel information corresponding to a first channel. The first wireless digital burst of the mobile television broadcast signal 155, as with all other wireless digital bursts of the mobile television broadcast signal 155 discussed herein, may be received by the mobile television tuner 134 from the second antenna 136. More particularly, the mobile television tuner 134 may be controlled by the control logic 128 to turn on at times at which wireless digital bursts carrying first channel information corresponding to the first channel are included in the mobile television broadcast signal 155, such as a DVB-H signal to which the mobile television tuner 134 is tuned. Turning on the tuner may include, for example, increasing the power supplied to the tuner to enable the tuner to receive a wireless digital burst. Thus, as shown in FIG. 3, transmitted first channel signals 300, 302, and 304 are received by the mobile television tuner 134 during times T_{ON1}, where the notation “T_{ON1}” is shown only once for simplicity. The transmitted first channel signals 300, 302, and 304 include the first channel information. Times T_{OFF1}, one notation of which is shown in FIG. 3, correspond to times at which the transmitted first channel signals 300, 302, and 304 are not received by the mobile television tuner 134.

Referring back to FIG. 2, in block 204, the method includes providing first video based on the first channel information. Providing the first video based on the first channel information may include, for example, sending the first video to a display block for display on a display of the display block, wirelessly transmitting the first video for display on a display at a location remote from that of the handheld device, providing the first video to a display of the handheld device, or any suitable providing of the first video. The providing of the first video based on the first channel information, as with all providing of video discussed herein, may include any necessary buffering as known in the art in addition to buffering operations discussed below with respect to, for example, block 212. As shown in FIG. 3, in block 204 the first channel signals 300, 302, and 304 may be processed by the mobile television tuner 134, the demodulation module 138, the filtering module 140, and the error correction module 142 to produce, respectively, the corresponding modulated mobile television channel information 139, demodulated data packets 141, filtered data packets 143, and first error-corrected data packets 145. For purposes of illustration only, the corresponding modulated mobile television channel information 139, demodulated data packets 141, filtered data packets 143, and first error-corrected data packets 145, though distinct from one another as described above, have been commonly labeled “C1” in FIG. 3 throughout the various stages of this processing. Moreover, it will be understood that the corresponding modulated mobile television channel information 139, demodulated data packets 141, filtered data packets 143, and error-corrected data packets 145 include the first channel information.

The first channel information, included in the first error-corrected data packets 145, is input from the error correction module 142 to the interface 132. From the interface 132, the first channel information, included in the channel data packets 151, is output to a display block (not shown in FIGS. 1 and 3), to a wireless transmitter (not shown in FIGS. 1 and 3) which transmits the first channel information to a location remote from that of the handheld device 100, to the audio/visual codecs or accelerators module 124 if the first video is to be displayed on the display 126, or to any suitable location.

In the embodiment wherein the first channel information is output to the audio/visual codecs or accelerators module 124, the audio/visual codecs or accelerators module 124 decodes the channel data packets 151 to produce the corresponding voice and video data 125 to be output through peripheral devices 120, such as audio speakers, and the display 126. In one embodiment, the control logic 128 controls the display 126 to display the first video based on the first channel information. It will be noted that FIG. 3 is a simplified view of the cellular telephone portion 102 showing only the processor 114 and the audio/visual codecs or accelerators module 124 and the display 126 of the cellular telephone subsystem 112.

Referring again to FIG. 2, in block 206, the method includes reducing battery power consumption by turning off the tuner. For purposes of this disclosure, “turning off” the tuner refers to reducing the power supplied to the tuner, whether that reduction in power is partial or complete. For example, the control logic 128 may be operative to reduce power consumption by the battery 106 by turning off the mobile television tuner 134 at times at which the mobile television broadcast signal 155 does not include wireless digital bursts carrying the transmitted first channel signals 300, 302, and 304 corresponding to the first channel. In one embodiment, however, the mobile television broadcast signal 155 is a digital video broadcasting-terrestrial (“DVB-T”) signal, in which signals for all channels are transmitted at the same time in a continuous fashion. Accordingly, in this embodiment, the tuner is not turned off.

In block 208, the method includes determining a second channel to be displayed while providing the first video based on the first channel information. As will be recognized by one of ordinary skill in the art, the providing of a channel and the display of a channel, as those terms are used herein, refers to the providing of video and the displaying of video, respectively, based on channel information corresponding to that channel. In one embodiment, this determination includes predicting a next channel that will be displayed based on detected user channel navigation information. The detected user channel navigation information may be, for example, information gathered from a user's prior channel usage or a user's usage and navigation of an ESG. In another embodiment, the method includes predicting multiple next channels that will be displayed based on the detected user channel navigation information. For purposes of the present disclosure, only one next channel will be assumed, but in the context of the embodiment wherein multiple next channels are predicted, “second channel information” as used hereinafter means channel information for all such next channels that are predicted. The control logic 128 may be operative to perform this determination and prediction while, in one embodiment, controlling the display 126 to display the first video based on the first channel information.

In block 210, the method includes turning on the tuner to receive a second wireless digital burst including second channel information corresponding to the second channel to be displayed. By turning on the tuner only during the transmission of wireless digital bursts including channel information corresponding to channels to be displayed, power of the battery, such as the battery 106, can be conserved. In one embodiment, one or more of a corresponding demodulation module, a filtering module, and an error correction module are also turned on in block 210.

For example, the control logic 128 may be operative to control the mobile television tuner 134 to receive the second wireless digital burst of the mobile television broadcast signal 155. More particularly, the control logic 128 may be operative to control the mobile television tuner 134 to turn on at times T_{ON2}, one of which is denoted in FIG. 3, at which wireless digital bursts of the mobile television broadcast signal 155 carry transmitted second channel signals 306 and 308 corresponding to the second channel to be displayed. The transmitted second channel signals 306 and 308 include the second channel information. As denoted in FIG. 3, times T_{OFF2}, one of which is shown in FIG. 3, correspond to times at which the mobile television broadcast signal 155 does not carry the transmitted second channel signals 306 and 308.

In one embodiment, the corresponding demodulation module 138, the filtering module 140, and the error correction module 142 are turned on when the control logic 128 controls the mobile television tuner 134 to receive the second wireless digital burst of the mobile television broadcast signal 155. The demodulation module 138, the filtering module 140, and the error correction module 142 may be turned on, in one embodiment, under the control of the control logic 128.

Referring back to FIG. 2, in block 212, the method includes buffering the second channel information in a buffer while providing the first video based on the first channel information. If necessary during operation of the handheld device, the first channel information may also be buffered in the buffer, and the channel information corresponding to the video currently being provided is given priority in usage of the buffer. In addition, block 212 may include periodically refreshing the buffered second channel information, such as each time the exemplary operation in block 202 is performed, in order to ensure that the buffer holds the most recent second channel information. For example, as shown in FIG. 3, the control logic 128 may be operative to control buffering and refreshing of the second error-corrected data packets 147 in the buffer 144 while controlling the transmission of the first error-corrected data packets 145 from the error correction module 142 to the interface 132, in one embodiment, controlling the display 126 to display the first video based on the first channel information. As discussed above, the first error-corrected data packets 145 include the first channel information; similarly, the second error-corrected data packets 147 include the second channel information. More particularly, the second error-corrected data packets 147 include error-corrected second channel information.

For example, in controlling the buffering and refreshing of the second channel information in the buffer 144, the control logic 128 may be operative to control the demodulation module 138 to demodulate the modulated mobile television channel information 139 produced by the mobile television tuner 134 in response to the transmitted second channel signals 306 and 308. As discussed above, the demodulation module 138 produces demodulated data packets 141, which include the second channel information. More particularly, the demodulated data packets 141 include demodulated second channel information. The control logic 128 may be further operative to control the filtering module 140 to filter the demodulated data packets 141 to produce the filtered data packets 143, which include the second channel information. More particularly, the filtered data packets 143 include filtered second channel information. The control logic 128 may be further operative to control the error correction module 142 to process the filtered data packets 143 to produce the second error-corrected data packets 147. For purposes of illustration only, the corresponding modulated mobile television channel information 139, demodulated data packets 141, filtered data packets 143, and second error-corrected data packets 147, though distinct from one another as described above, have been commonly labeled “C2” in FIG. 3 throughout the various stages of this processing. As discussed in more detail below with respect to FIG. 5, buffering of the second channel information in the buffer 144 significantly reduces the delay between the time at which a user of the handheld device, such as the handheld device 100, inputs a command to select the second channel for display and the time at which the second channel is actually provided and displayed, such as on the display 126.

Referring back to FIG. 2, in block 214, the method includes reducing battery power consumption by turning off the tuner. For example, the control logic 128 may be operative to reduce power consumption by the battery 106 by turning off the mobile television tuner 134 at times at which the mobile television broadcast signal 155 does not include wireless digital bursts carrying the transmitted first channel signals 300, 302, and 304 corresponding to the first channel or the transmitted second channel signals 306 and 308 corresponding to the second channel.

In block 216, the method includes turning on the tuner to receive a third wireless digital burst. The third wireless digital burst may include the first channel information or channel information for another mobile television channel to be displayed. For example, the control logic 128 may be operative to control the mobile television tuner 134 to receive the third wireless digital burst of the mobile television broadcast signal 155. More particularly, the control logic 128 may be operative to control the mobile television tuner 134 to turn on at times at which the mobile television broadcast signal 155 includes wireless digital bursts carrying channel information corresponding to the first channel or other mobile television channel to be displayed.

With continued reference to block 216, in one embodiment, the third wireless digital burst includes channel information for another channel to be displayed, such as third channel information corresponding to a third channel. In this embodiment, block 216 includes buffering the third channel information in the buffer while providing the first video based on the first channel information. For example, the control logic 128 may be operative to control buffering of the third channel information in the buffer 144 while, in one embodiment, controlling the display 126 to display the first video based on the first channel information. Thus, the buffer 144 includes the second channel information and the third channel information. The number of channels which may be buffered in accordance with the present method depends upon the memory available in the handheld device, such as the handheld device 100, used in conjunction with the method.

At block 218, the method ends. However, it is to be understood that the method and the various exemplary operations thereof as described above may be repeated as desired to provide continuous mobile television service to the handheld device, such as the handheld device 100. Moreover, the various exemplary operations of the method as described above may be performed in any suitable order and the depiction of the exemplary operations in the order shown in FIG. 2 is for purposes of illustration, not limitation. By way of example only, the exemplary operation in block 214, in which battery power consumption is reduced by turning off the tuner, may be performed before the exemplary operation in block 212, in which the second channel information is buffered in the buffer while providing the first video based on the first channel information.

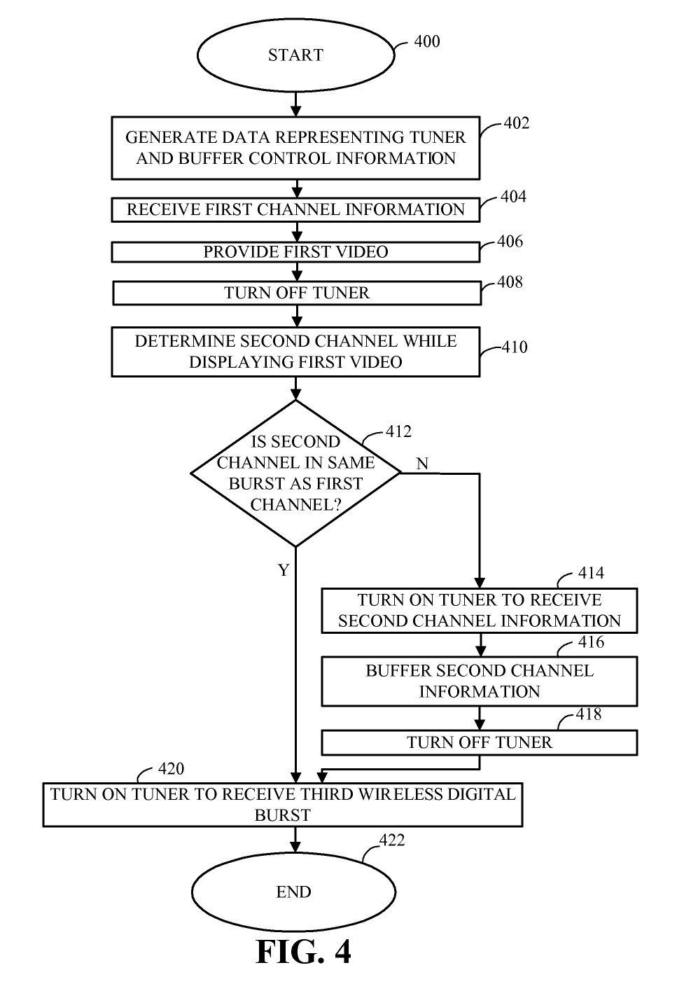

Referring now to FIG. 4, another exemplary method of controlling mobile television channel selection in a handheld device is illustrated. The method includes further exemplary operations in addition to those shown in the method of FIG. 2. The method begins at block 400. In block 402, the method includes generating data representing tuner and buffer control information for a tuner and a buffer. The data representing tuner and buffer control information may include, for example, operating parameters for the tuner and the buffer, such as addressing information, and executable instructions to be executed on a processor, such as the processor 114 in order to control the tuner and the buffer to operate in the manner described herein. For example, the control logic 128 may be operative to generate the data representing tuner and buffer control information, or the data representing tuner and buffer control information may be generated elsewhere on the processor 114, such as by a suitable software application executing on the processor 114, by firmware, by hardware, or by a suitable combination thereof. The tuner and the buffer may be, for example, the mobile television tuner 134 and the buffer 144. The tuner and buffer control information may be transmitted to the mobile television tuner 134 and the buffer 144 as part of the mobile television portion control signals 135.

In block 404, the method includes controlling a tuner, such as the mobile television tuner 134, to receive a first wireless digital burst including first channel information corresponding to a first channel.

In block 406, the method includes providing first video based on the first channel information.

In block 408, the method includes reducing battery power consumption by turning off the tuner.

In block 410, the method includes determining a second channel to be displayed while providing the first video based on the first channel information.

In block 412, the method includes determining whether the second channel information is transmitted in the same wireless digital burst as the first channel information. As discussed above, each wireless digital burst may contain channel information corresponding to a single or more channels. This determination may be made by, for example, the control logic 128 through communication of the processor 114 with the mobile television tuner 134 via the mobile television portion control signals 135. Alternatively, the determination may be made by the mobile television tuner 134 and the result of the determination may be communicated to the control logic 128 via the mobile television portion control signals 135. If the second channel information is not transmitted in the same wireless digital burst as the first channel information, flow proceeds to block 414. If the second channel information is transmitted in the same wireless digital burst as the first channel information, flow proceeds to block 420.

In the event that flow proceeds to block 414, the method includes, in block 414, turning on the tuner to receive a second wireless digital burst including second channel information corresponding to the second channel to be displayed. In one embodiment, one or more of a corresponding demodulation module, a filtering module, and an error correction module are also turned on in block 414.

In block 416, the method includes buffering the second channel information in a buffer while providing the first video based on the first channel information. Block 416 may further include periodically refreshing the buffered data in order that the buffer holds the latest second channel information.

In block 418, the method includes reducing battery power consumption by turning off the tuner. From block 418, flow may proceed, for example, to block 420.

In the event that flow proceeds to block 420, such as from block 412 or block 418, the method includes turning on the tuner to receive a third wireless digital burst. The third wireless digital burst may include the first channel information or channel information for another mobile television channel to be displayed. In one embodiment, the third wireless digital burst includes channel information for another channel to be displayed, such as third channel information corresponding to a third channel. In this embodiment, block 420 includes buffering the third channel information in the buffer while providing the first video based on the first channel information.

Because flow proceeds from block 412 to block 420 if the second channel information is transmitted in the same wireless digital burst as the first channel information, under these circumstances the second channel information is not buffered in the buffer, such as the buffer 144, while providing the first video based on the first channel information. Namely, because the second channel information is transmitted in the same wireless digital burst as the first channel information, the second channel information may be processed by a mobile television receiver, such as the mobile television receiver 130, concurrently with the first channel information, thus reducing the delay between the time at which a user of the handheld device, such as the handheld device 100, inputs a command to select the second channel and the time at which the second channel is actually provided and displayed, such as on the display 126. Thus, for example, second error-corrected data packets 147 may be input to the interface 132 without being input to the buffer 144, and the control logic 128 may control, in one embodiment, which of the first channel and second channel are displayed at a particular time.

In an alternate embodiment, when the second channel information is transmitted in the same wireless digital burst as the first channel information, the second channel information is still buffered in the buffer while providing the first video based on the first channel information. This buffering produces the desirable result of allowing a user of the handheld device to view second video based on the second channel information, as discussed in detail with respect to FIG. 5, at a later time desired by the user. Thus, for example, the user of the handheld device may view second video based on the second channel information even when the second channel information was sent while the first channel was being provided.

The method of FIG. 4 ends at block 422. However, it is to be understood that the method and the various exemplary operations thereof as described above may be repeated as desired to provide continuous mobile television service to the handheld device, such as the handheld device 100. Moreover, as with the method of FIG. 2, the various exemplary operations of the method of FIG. 4 as described above may be performed in any suitable order and the depiction of the exemplary operations in the order shown in FIG. 4 is for purposes of illustration, not limitation.

Referring now to FIG. 5, another exemplary method of controlling mobile television channel selection in a handheld device is illustrated. The method includes further exemplary operations in addition to those shown in the methods of FIGS. 2 and 4. The method is performed when a user of the handheld device, such as the handheld device 100, inputs a command to select a second channel, such as the second channel discussed above with respect to FIGS. 2-4, for display. For example, if the handheld device 100 is used, the user may select the second channel through a suitable input through peripheral devices 120, such as a keypad.

The method begins at block 500. In block 502, the method includes accessing second channel information, such as the second channel information of FIGS. 2-4, from a buffer. For example, in the handheld device 100, the control logic 128 may be operative to control accessing of the second error-corrected data packets 147 from the buffer 144 to generate the buffered data packets 149 for input to the interface 132. The buffered data packets 149 include the second channel information. Further, in one embodiment, the control logic 128 may be operative to control simultaneous accessing of multiple second error-corrected data packets 147 from multiple buffer locations.

In block 504, the method includes providing second video based on the second channel information. For example, the interface 132 may provide the channel data packets 151 to the audio/visual codecs or accelerators module 124 for display on the display 126 in the manner described with respect to FIG. 1. In one embodiment, the control logic 128 may be operative to control the display 126 to display the second video based on the second channel information. Alternatively, the second video may be provided in any suitable manner such as discussed above with respect to the first video in block 204. Because the second channel information is available from the buffer 144 at the time the user of the handheld device 100 inputs the command to select the second channel for display, the delay between the time at which the user inputs the command and the time at which the second channel is actually provided and displayed, such as on the display 126, is significantly reduced. For example, instead of a one to two second delay as observed with known mobile television receivers, the delay may be only one half of a second.

In block 506, the method includes controlling a tuner in a mobile television receiver of the handheld device to receive a wireless digital burst including the first channel information corresponding to the first channel. In the handheld device 100, the control logic 128 may be operative to perform this control in the manner described above.

In block 508, the method includes reducing battery power consumption by turning off the tuner. For example, the control logic 128 may be operative to reduce power consumption by the battery 106 by turning off the mobile television tuner 134 at times at which the mobile television broadcast signal 155 does not include wireless digital bursts carrying the transmitted first channel signals 300, 302, and 304 corresponding to the first channel or the transmitted second channel signals 306 and 308 corresponding to the second channel.

In block 510, the method optionally includes buffering the first channel information in the buffer while providing the second video based on the second channel information. Block 510 may further include periodically refreshing the buffered data in order that the buffer holds the latest first channel information.

For example, the control logic 128 may be operative to control buffering and refreshing of the second error-corrected data packets 147 in the buffer 144 while, in one embodiment, controlling the display 126 to display the second video based on the second channel information. As will be recognized by one of ordinary skill in the art upon review of the present disclosure, when the first channel information is buffered in block 510, the error correction module 142 outputs the second error-corrected data packets 147 such that the second error-corrected data packets 147 include the first channel information. The error correction module 142 may, for example, be controlled by the control logic 128 to output the second error-corrected data packets 147 in this manner.

If step 510 is not performed, the first channel information is not buffered in the buffer and undergoes the same processing as in the method of FIG. 2. Thus, the first video based on the first channel information and the second video based on the second channel information may be displayed at the same time. This result is useful in, for example, picture-in-picture (“PIP”) applications.

At block 512, the method ends. However, it is to be understood that the method and the various exemplary operations thereof as described above may be repeated to provide continuous mobile television service to the handheld device, such as the handheld device 100. Moreover, the various exemplary operations of the method as described above may be performed in any suitable order and the depiction of the exemplary operations in the order shown in FIG. 5 is for purposes of illustration, not limitation. By way of example only, the exemplary operation in block 510, in which the first channel information is buffered in the buffer while providing the second video based on the second channel information, may be performed before the exemplary operation in block 508, in which battery power consumption is reduced by turning off the tuner.

As will be recognized by one of ordinary skill in the art upon review of the present disclosure, each of the methods of FIGS. 2, 4, and 5 may be performed in a complementary manner by treating the first channel as the second channel and vice versa. Moreover, the methods may be performed in sequence or in combination with one another as appropriate. For example, after the performance of the method of FIG. 5 as described above, suitable exemplary operations of the method of FIG. 2 may be performed in a manner complementary to that described above; that is, by treating the first channel as the second channel and vice versa. Thus, additional wireless digital bursts including the second channel information corresponding to the second channel may be received in order to provide the second video. In this situation, as discussed above, the second channel information is given priority in usage of the buffer over the first channel information.

In another embodiment, the memory includes executable instructions that when executed cause one or more processors to control a tuner of a handheld device to receive a first wireless digital burst including first channel information corresponding to a first channel. As noted above, the memory may be distributed memory in one or more Internet servers, any other suitable memory remote from the handheld device, or any suitable combination of memory local to the handheld device and remote from the handheld device. In addition, if desired, the executable instructions may also cause the one or more processors to reduce power consumption by a battery by turning off the tuner. The executable instructions may also cause the one or more processors to determine a second channel to be displayed while first video based on the first channel information is displayed on a display. The display may be either the display of the handheld device or, for example, a display of a display block, a display at a location remote from that of the handheld device, or any suitable display. The executable instructions may also cause the one or more processors to control the tuner to receive a second wireless digital burst including second channel information corresponding to the second channel and control buffering of the second channel information in a buffer while the first video based on the first channel information is displayed on the display. In addition, if desired, the executable instructions may also cause the one or more processors to reduce power consumption by the battery by again turning off the tuner. The executable instructions may also cause the one or more processors to control the tuner to receive a third wireless digital burst.

Further, the executable instructions may cause the one or more processors to generate data representing tuner and buffer control information for the tuner and the buffer. The executable instructions may also cause the one or more processors to predict a next channel that will be displayed based on detected user channel navigation information when determining the second channel to be displayed.

In one embodiment, the third wireless digital burst received by the tuner under the control of the one or more processors may include third channel information corresponding to a third channel. In this embodiment, the executable instructions may also cause the one or more processors to control buffering of the third channel information in the buffer while the first video based on the first channel information is displayed on the display.

Further still, the executable instructions may cause the one or more processors to control accessing of the second channel information from the buffer when the second channel is selected for display. The executable instructions may also cause the one or more processors to: (a) control the tuner to receive a fourth wireless digital burst including the first channel information corresponding to the first channel when the second channel is selected for display, and (b) control buffering of the first channel information in the buffer when the second channel is selected for display.

Accordingly, among other advantages, one or more embodiments provide or cause buffering of, for example, second channel information in a buffer while providing first video based on first channel information in order to allow quick access to and providing of the second video based on the second channel information when a user of a handheld device inputs a command to select the second channel for display. Consequently, one or more embodiments provide, among other things, a significant reduction in the delay between the time at which the user of the handheld device inputs the command to select the second channel for display and the time at which the second channel is actually provided and displayed.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method comprising:
controlling a tuner to receive a first wireless digital burst including first channel information corresponding to a first channel;
providing first video based on the first channel information;
reducing battery power consumption by turning off the tuner;
turning on the tuner to receive a second wireless digital burst including second channel information corresponding to the second channel;
buffering the second channel information in a buffer while providing the first video based on the first channel information; and
reducing battery power consumption by turning off the tuner.

2. The method of claim 1, further comprising generating data representing tuner and buffer control information for the tuner and the buffer and determining a second channel to be displayed while providing the first video based on the first channel information.

3. The method of claim 1, wherein determining the second channel to be displayed comprises predicting a next channel that will be displayed based on detected user channel navigation information.

4. The method of claim 1, further comprising accessing the second channel information from the buffer and providing second video based on the second channel information when the second channel is selected for display.

5. The method of claim 4, further comprising:
controlling the tuner to receive a fourth wireless digital burst including the first channel information corresponding to the first channel; and
buffering the first channel information in the buffer while providing the second video based on the second channel information.

6. The method of claim 1, comprising turning on the tuner to receive a third wireless digital burst and wherein the third wireless digital burst includes third channel information corresponding to a third channel, and further comprising buffering the third channel information in the buffer while providing the first video based on the first channel information.

7. The method of claim 1, wherein the tuner is tuned to a digital video broadcasting-handheld signal.

8. A handheld device comprising:
a battery;
a display;
a tuner;
a buffer; and
control logic operatively coupled to the battery and the tuner, wherein the control logic is operative to:
control the tuner to receive a first wireless digital burst including first channel information corresponding to a first channel;
control the display to display first video based on the first channel information;
reduce power consumption by the battery by turning off the tuner;
control the tuner to receive a second wireless digital burst including second channel information corresponding to the second channel;
control buffering of the second channel information in the buffer while controlling the display to display the first video based on the first channel information; and
reduce power consumption by the battery by turning off the tuner.

9. The handheld device of claim 8, wherein the control logic is further operative to determine a second channel to be displayed while controlling the display to display the first video based on the first channel information and to generate data representing tuner and buffer control information for the tuner and the buffer.

10. The handheld device of claim 8, wherein the control logic is further operative to predict a next channel that will be displayed based on detected user channel navigation information when determining the second channel to be displayed.

11. The handheld device of claim 8, wherein the logic is operative to control the tuner to receive a third wireless digital burst and wherein the third wireless digital burst includes third channel information corresponding to a third channel, and wherein the control logic is further operative to control buffering of the third channel information in the buffer while controlling the display to display the first video based on the first channel information.

12. The handheld device of claim 8, wherein the control logic is further operative to control accessing of the second channel information from the buffer and to control the display to display the second video based on the second channel information when the second channel is selected for display.

13. The handheld device of claim 12, wherein the control logic is further operative to:
control the tuner to receive a fourth wireless digital burst including the first channel information corresponding to the first channel; and
control buffering of the first channel information in the buffer while controlling the display to display the second video based on the second channel information.

14. The handheld device of claim 8, wherein the tuner is tuned to a digital video broadcasting-handheld signal.

15. Memory comprising:
executable instructions that when executed cause one or more processors to:
control a tuner to receive a first wireless digital burst including first channel information corresponding to a first channel;
determine a second channel to be displayed while first video based on the first channel information is displayed on a display;
control the tuner to receive a second wireless digital burst including second channel information corresponding to the second channel; and
control buffering of the second channel information in a buffer while the first video based on the first channel information is displayed on the display.

16. The memory of claim 15, wherein the executable instructions when executed further cause the one or more processors to generate data representing tuner and buffer control information for the tuner and the buffer.

17. The memory of claim 15, wherein the executable instructions when executed further cause the one or more processors to predict a next channel that will be displayed based on detected user channel navigation information when determining the second channel to be displayed.

18. The memory of claim 15, wherein the executable instructions when executed further cause the one or more processors to control the tuner to receive a third wireless digital burst and wherein the third wireless digital burst includes third channel information corresponding to a third channel, and wherein the executable instructions when executed further cause the one or more processors to control buffering of the third channel information in the buffer while the first video based on the first channel information is displayed on the display.

19. The memory of claim 15, wherein the executable instructions when executed further cause the one or more processors to control accessing of the second channel information from the buffer when the second channel is selected for display.

20. The memory of claim 19, wherein the executable instructions when executed further cause the one or more processors to:
control the tuner to receive a fourth wireless digital burst including the first channel information corresponding to the first channel when the second channel is selected for display; and
control buffering of the first channel information in the buffer when the second channel is selected for display.
